(19) United States
(12) Patent Application Publication
(10) Pub. No.: US 2024/0365816 A1
(43) Pub. Date: Nov. 7, 2024

(54) METHODS AND COMPOSITION FOR PALATABLE PET FOODS

(71) Applicant: Société des Produits Nestlé S.A., vevey (CH)

(72) Inventors: Pascal Vanacker, AMIENS (FR); Arne GLABASNIA, Murten (CH); Jiyuan ZHANG, Lausanne (CH); Philippe POLLIEN, FOREL / Lavaux (CH); Hanne Vlaeminck, ST. LOUIS, MO (US)

(73) Assignee: Société des Produits Nestlé S.A., vevey (CH)

(21) Appl. No.: 18/638,037

(22) Filed: Apr. 17, 2024

Related U.S. Application Data
(60) Provisional application No. 63/500,487, filed on May 5, 2023.

(51) Int. Cl. A23K 20/121; A23K 20/105; A23K 20/137; A23K 20/147; A23K 20/158; A23K 50/48

(52) U.S. Cl. CPC A23K 20/121; A23K 20/105; A23K 20/137; A23K 20/147; A23K 20/158; A23K 50/48

(57) ABSTRACT

Pet food compositions and methods of making such pet food compositions are disclosed including utilizing a palatant selected from the group consisting of dimethyl sulphide, isoamyl alcohol, 2-methyloxolan-3-one, 2,5-dimethylpyrazine, 2-ethyl-3,5-dimethylpyrazine, furfural, furfuryl alcohol, and combinations thereof, wherein the composition has at least one combination of compounds as provided in Table 10 in ratios as provided in Table 10.

### CROSS REFERENCE TO RELATED APPLICATIONS

This application claims priority to U.S. Provisional Application Ser. No. 63/500,487 filed May 5, 2023, the disclosure of which is incorporated in its entirety herein by this reference.

### BACKGROUND

There are various ways of enhancing the palatability of comestible compositions. Addition of one or more ingredients that provide an appealing aroma or flavor may increase palatability. Ingredients that affect food qualities such as aroma, flavor, texture, or mouthfeel, may also affect palatability. For some compositions, increasing sweetness or increasing fat or salt content may enhance palatability for some animals. Flavor enhancers, such as glutamic acid or its salts and various nucleotide or ribonucleotide compounds, are also known in the art to be palatability enhancers.

The existing solutions for palatability enhancement in wet food for cats, such as chunks-in-gravy compositions, are usually based on Maillard reaction precursors. These precursors are composed of carbonyl, nitrogen and sulfur compounds such as amino acids, vitamins, and reducing sugars that may be incorporated in the pet food, e.g., chunks and/or into the gravy. However, using high inclusion rates of these components may be perceived negatively by pet owners because these components may be classified as non-natural or may be perceived as potentially having a negative effect on pet health.

### SUMMARY

In one embodiment, a pet food composition comprising a palatant selected from the group consisting of dimethyl sulphide, isoamyl alcohol, 2-methyloxolan-3-one, 2,5-dimethylpyrazine, 2-ethyl-3,5-dimethylpyrazine, furfural, furfuryl alcohol, and combinations thereof, wherein the composition has at least one combination of compounds as provided in Table 10 in ratios as provided in Table 10.

In another embodiment, a method of making a pet food composition can comprise incorporating a precursor of a palatant, an ingredient containing the palatant, or the palatant, wherein the palatant is selected from the group consisting of dimethyl sulphide, isoamyl alcohol, 2-methyloxolan-3-one, 2,5-dimethylpyrazine, 2-ethyl-3,5-dimethylpyrazine, furfural, furfuryl alcohol, and combinations thereof, into the pet food; and incorporating a combination of compounds in table 10 in ratios as provided in Table 10 into the pet food, wherein the compounds are formed from precursors that are added to the pet food, are added as ingredients that contain the compounds, or are added directly to the pet food;

Such methods and compositions can have the palatants in an amount effective to enhance palatability of the pet food composition

Additional features and advantages are described herein and will be apparent from the following Detailed Description.

### DETAILED DESCRIPTION

As used in this disclosure and the appended claims, the singular forms “a,” “an” and “the” include plural referents unless the context clearly dictates otherwise. Thus, for example, reference to “a gravy” or “the gravy” includes a single gravy and also two or more gravies.

The words “comprise,” “comprises” and “comprising” are to be interpreted inclusively rather than exclusively. Likewise, the terms “include,” “including” and “or” should all be construed to be inclusive, unless such a construction is clearly prohibited from the context. However, the compositions disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein may be combined with any other embodiment disclosed herein unless expressly stated otherwise.

The terms “at least one of” and “and/or” used respectively in the context of “at least one of X or Y” and “X and/or Y” should be interpreted as “X without Y,” or “Y without X,” or “both X and Y.” Where used herein, the terms “example” and “such as,” particularly when followed by a listing of terms, are merely exemplary and illustrative and should not be deemed to be exclusive or comprehensive.

All percentages expressed herein are by weight of the total weight of the referenced composition unless expressed otherwise. As used herein, “approximately,” “about” and “substantially” refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number.

The terms “food,” “food product” and “food composition” mean a product or composition that is intended for ingestion by an animal and provides at least one nutrient to the animal. The term “animal” or “pet” means any animal which could benefit from or enjoy the food compositions and products provided by the present disclosure. For example, the pet may be an avian, bovine, canine, equine, feline, hircine, lupine, murine, ovine, or porcine animal. The pet may be any suitable animal, and the present disclosure is not limited to a specific pet animal. The term “companion animal” means a dog or a cat.

The term “pet food” means any composition formulated to be consumed by a pet. A “dry” food composition has less than 10 wt. % moisture and/or a water activity less than 0.64, preferably both. A “semi-moist” food composition has 11 wt. % to 20 wt. % moisture and/or a water activity of 0.64 to 0.75, preferably both. A “wet” food composition has more than 20 wt. % moisture and/or a water activity higher than 0.75, preferably both.

The term “palatant” includes the compound as well as any precursors that form the compound during processing or manufacturing of the pet food.

The term “combination of compounds as provided in Table 10” includes the compounds listed in Table 10 as well as any precursors that form the compounds listed in Table 10 during processing or manufacturing of the pet food.

The term “chunks” means a plurality of separate food bodies, preferably pieces of dry or semi-moist pet food which may have a pellet shape or any other shape. The chunks may contain one or more of meat, meat by-products, cereals, or vegetable proteins. Non-limiting examples of chunks include particulates; pellets; pieces of pet food, dehydrated meat, meat analog, vegetables, and combinations thereof; and pet snacks, such as meat or vegetable jerky, rawhide, and biscuits. The chunks may vary in size depending upon the animal that will consume the product, e.g., the type, age, health, or size of the animal. For example, chunk sizes for cats typically range from 3 mm to 30 mm, preferably 8 mm to 20 mm, on the longest side. A “gravy” is a flowable edible composition that preferably comprises water and at least one of a starch or a gum, and preferably has the form of a gel or a sol.

The terms “loaf,” and “mousse” are used interchangeably herein. A loaf composition is a shaped or molded mass of pet food that preferably is substantially homogeneous. A loaf composition may have a structure that maintains, during and after removal from the packaging at ambient temperature and ambient pressure, the shape imparted on the loaf composition by the packaging. For example, in some embodiments, a loaf composition removed from a cylindrical can will have a cylindrical shape having a horizontal cross-section with substantially the same dimensions as a corresponding horizontal cross-section of the interior of the can.

The terms “chunk-in-loaf,” “HsCC,” and “terrine” are used interchangeably herein. These terms refer to a loaf product with chunks added.

The term “2-methyloxolan-3-one” refers to 2-methyltetrahydrofuran-3-one.

The term “enhanced palatability” and similar terms mean that at least one of the palatants ore combination of compounds as disclosed herein improves the palatability of a food composition relative to an identically formulated food composition lacking the palatant or combination of compounds. “Palatability” refers to a quality of a comestible composition that makes it appealing or pleasing to one or more of an animal's senses, particularly the senses of taste and smell. As used herein, whenever an animal shows a preference, for example, for one of two or more foods, the preferred food is more “palatable” and has greater “palatability.” For companion animals and other non-human animals, the relative palatability of one food compared to one or more other foods may be determined, for example, in side-by-side, free-choice comparisons, e.g., by relative consumption of the foods, or other appropriate measures of preference indicative of palatability.

The term “complete and balanced” when referring to a food composition means a food composition that contains all known required nutrients in appropriate amounts and proportions based on recommendations of recognized authorities in the field of animal nutrition, and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO) as of Jan. 1, 2022.

The methods and compositions and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein may be used, the preferred devices, methods, articles of manufacture, or other means or materials are described herein.

Preferred embodiments provided by the present disclosure are described hereafter. In one embodiment, a pet food composition comprising a palatant selected from the group consisting of dimethyl sulphide, isoamyl alcohol, 2-methyloxolan-3-one, 2,5-dimethylpyrazine, 2-ethyl-3,5-dimethylpyrazine, furfural, furfuryl alcohol, and combinations thereof, wherein the composition has at least one combination of compounds as provided in Table 10 in ratios as provided in Table 10. In some aspects, the pet food composition can further include additional combinations from Table 10, such as a second combination, a third combination, a fourth combination, a fifth combination, a sixth combination, a seventh combination, an eighth combination, a ninth combination, a tenth combination, or more.

In another embodiment, a method of making a pet food composition can comprise incorporating a precursor of a palatant, an ingredient containing the palatant, or the palatant, wherein the palatant is selected from the group consisting of dimethyl sulphide, isoamyl alcohol, 2-methyloxolan-3-one, 2,5-dimethylpyrazine, 2-ethyl-3,5-dimethylpyrazine, furfural, furfuryl alcohol, and combinations thereof, into the pet food; and incorporating a combination of compounds in table 10 in ratios as provided in Table 10 into the pet food, wherein the compounds are formed from precursors that are added to the pet food, are added as ingredients that contain the compounds, or are added directly to the pet food. In some aspects, the method can further include additional combinations from Table 10, such as a second combination, a third combination, a fourth combination, a fifth combination, a sixth combination, a seventh combination, an eighth combination, a ninth combination, a tenth combination, or more.

A preferred embodiment of the pet food composition is a wet pet food disclosed herein, such as a chunks-in-gravy composition, or a loaf or terrine composition.

Preferably, the palatant(s) can be added to the wet pet food (e.g., added to the chunks, the gravy, and/or the loaf). Such palatants can be added directly in free form, or as part of an ingredient, or added as flavor precursors that form the palatants during processing. The palatants or precursors can be added in an amount that enhances palatability of the pet food. The palatants and/or precursors can be added in an amount ranging from about 0.1% to about 5%, or in some aspect, from about 0.1%, 0.5%, 1% to about 0.5%, 1%, 2%, 3%, 4%, or 5%, although other amounts outside these ranges are also contemplated herein.

Additionally, the methods and compositions generally comprise a combination of compounds as described in Table 10 disclosed herein in ratios described in Table 10. Such compounds can be added in various amounts provided that the ratio is met.

In some embodiments of the method (e.g., to enhance palatability), an initial pet food formulation comprises at least one Maillard reaction precursor. In some embodiments, the pet food is free or substantially free of any phosphate, or polyphosphate salts.

Such methods of making a pet food composition can comprise admixing various ingredients that provide protein, fat, and carbohydrates to form an admixture; and optionally retorting the admixture to form a pet food composition. The method may further comprise sealing the pet food in a container prior to retorting.

In some embodiments, the wet pet food composition has no greater than about 2.0 wt. % of a polyphosphate compound, preferably no greater than about 1.0 wt. % polyphosphate, more preferably no greater than about 0.5 wt. % polyphosphate, most preferably approximately zero polyphosphate. Such polyphosphate compounds include disodium diphosphate (or pyrophosphate), trisodium diphosphate (or pyrophosphate), tetrasodium or tetrapotassium diphosphate (or pyrophosphate), disodium phosphate, trisodium phosphate, dipotassium phosphate, potassium polyphosphate, sodium polyphosphate, and others as known in the art.

The pet foods disclosed herein may be any food formulated for consumption by a pet such as a dog or cat. In an embodiment, the pet food provides complete nutrition as defined by the Association of American Feed Control Officials (AAFCO) and which depends on the type of animal for which the composition is intended (e.g., a dog or a cat). In another embodiment, the composition can be a supplement. Such a supplement can be added to a food composition or be administered in conjunction with a food composition, or administered separately.

The pet food described herein (e.g., chunks-in-gravy or loaf) may be filled and sealed into a package. Non-limiting examples of suitable package types include cans, pouches, glass container, and plastic containers. Packaging of the pet food comprising the palatants and ratio of compounds may comprise retorting the pet food in the package under time and temperature conditions sufficient for commercial sterilization. Typically, a retorting temperature of about 100° C. to 150° C. for approximately 5 to 90 minutes will produce a commercially sterile product. In some embodiments, the chunks or loaf may be mixed with one or more of gravy, gel, or condiment in the package before retorting.

In an embodiment, a suitable gravy may be prepared by heating a mixture of water, hydrocolloids (e.g., starch or gum), and condiments. Then the chunks and the gravy may be filled into the package in desired proportions. The ratio of the chunks to the gravy is preferably about 30:70 to about 70:30, for example about 40:60 to about 60:40.

Additionally or alternatively, the composition may be processed by frying, retorting, and/or another way to make the product shelf-stable. Then the product may then be packaged into any of a variety of different packages.

In another aspect of the present disclosure, a method of providing nutrition to a pet is provided. The pet may be a companion animal, preferably a cat. The method comprises administering a wet pet food made by any of the embodiments of the methods disclosed herein. For example, the method may comprise removing the pet food disclosed herein from a package and then administering the pet food to the pet.

As noted above, a preferred embodiment of the pet foods disclosed herein is a chunks-in-gravy composition. In other embodiments, the pet food is a loaf or terrine composition.

In a chunks-in-gravy composition, preferably the chunks are approximately evenly distributed throughout the composition, and the gravy may be approximately evenly distributed throughout the composition. For example, a chunks-in-gravy composition may be substantially uniform such that similarly sized sections of the composition have substantially the same amount of the chunks by volume and/or substantially the same amount of the gravy by volume. The chunks and the gravy may be present throughout the composition; for example, although the chunks may be visually distinguished from the gravy, in some embodiments the composition does not have distinct layers.

In some embodiments, the chunks in the composition may be in the form of an emulsion of meat and/or vegetable protein that is sliced into separate pieces. Non-limiting examples of meat emulsions for use in the chunks of the compositions are disclosed in U.S. Pat. Nos. 10,993,445; 10,470,470; 7,736,686; 7,344,745; 6,767,573; 6,692,787; 6,649,206; 6,436,463; 6,379,738; 5,567,466; and 4,781,939; U.S. Pat. Pub. No. 2015/0208689 A1; and PCT Applications WO 2008085293 A2 and WO 2012057826 A1; all incorporated herein by reference in their entireties. Other non-limiting examples of suitable chunks include chunks of real meat, such as skeletal tissue and non-skeletal muscle from mammals, fowl and fish, for example beef, pork, chicken, turkey, lamb, fish or combinations thereof.

In some embodiments, the chunks in the composition may optionally comprise meat by-products, such as non-rendered clean parts, other than meat, derived from slaughtered mammals, fowl, or fish. In some embodiments, the chunks may comprise any of the meat by-products approved for use in animal foods, such as mechanically deboned beef, chicken or fish; beef and pork liver; lungs; kidney; and the like. Thus, the term “meat” as used herein refers to non-dehydrated meat and/or meat by-products, including frozen materials. The present disclosures is not limited to a specific meat or combination of meats, and any meat known to the skilled artisan for making a food composition may be used in the chunks.

The chunks may comprise other ingredients in addition to any meat. For example, additives used in conventional meat emulsion products may be included in the chunks by being mixed with the meat prior to and/or after emulsification. These additives include salt, spices, seasoning, sugar and the like, in amounts sufficient to provide the product with desired taste characteristics.

One or more dry proteinaceous materials may be added to the meat prior to and/or after emulsification to improve emulsion stability and binding, impart flavor, and/or reduce formulation costs. Non-limiting examples of suitable dry proteinaceous materials are wheat gluten, soy flour, soy protein concentrate, soy protein isolate, egg albumin, nonfat dry milk and combinations thereof. The inclusion of the one or more dry proteinaceous materials in the emulsion may be advantageous because dry proteinaceous material enables the processor to use meat having a protein to fat ratio and myosin to total protein ratio which would otherwise be of marginal acceptability for use in preparing the chunks.

Nevertheless, in some embodiments, the chunks do not contain any meat. For example, vegetable protein may be used additionally or alternatively to any meat, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like.

The gravy may further comprise dextrose, ribose, fructose, and/or xylose, and may also include a colorant as desired. Ingredients that add flavor and/or aroma to the gravy may also be included as desired. The starch in the gravy may be a native starch, a modified starch or a combination thereof; and suitable gums include kappa-carrageenan, locust bean gum, guar gum and xanthan gum.

In various embodiments, the chunks and/or the gravy may comprise additional ingredients such as vitamins, minerals, amino acids, nucleic acids, fillers, palatability enhancers, binding agents, flavorants, stabilizers, emulsifiers, sweeteners, colorants, buffers, salts, coatings, condiments, preservatives, and the like known to skilled artisans. The additional ingredients may be included in the chunks by being mixed with the meat prior to and/or after emulsification.

Non-limiting examples of supplementary vitamins include vitamin A, any of the B vitamins, vitamin C, vitamin D, vitamin E, and vitamin K, including various salts, esters, or other derivatives of the foregoing. Non-limiting examples of minerals include calcium, phosphorous, potassium, sodium, iron, chloride, boron, copper, zinc, magnesium, manganese, iodine, selenium, and the like. Additional dietary supplements may also be included, for example, any form of niacin, pantothenic acid, inulin, folic acid, biotin, amino acids, and the like, as well as salts and derivatives thereof.

Stabilizers include substances that tend to increase the shelf life or the structure of the pet food such as preservatives, synergists and sequestrants, packaging gases, emulsifiers, thickeners, gelling agents, and plasticizers. Examples of emulsifiers and/or thickening agents include gelatin, cellulose ethers, starch, starch esters, starch ethers, and modified starches.

Examples of suitable flavorants include yeast, tallow, rendered animal meals (e.g., poultry, beef, lamb, pork), flavor extracts or blends (e.g., grilled beef), and the like. Suitable colorants that may be used in the meat analog chunks and/or the gravy include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; iron oxides; and any suitable food colorant known to the skilled artisan. Suitable spices that may be used in the meat analog chunks and/or the gravy include parsley, oregano, sage, rosemary, basil, thyme, chives and the like.

Selection of the additional ingredients and their amounts is known to skilled artisans. Specific amounts for each additional ingredient will depend on a variety of factors such as the ingredient included in the composition; the species of animal; the animal's age, body weight, general health, sex, and diet; the animal's consumption rate; the purpose for which the food composition is being administered to the animal; and the like. Therefore, the component and ingredient amounts may vary widely and may deviate from the preferred proportions described herein.

As such, the present pet food compositions can comprise protein, carbohydrates, fat, and fiber. In some embodiments, the pet food compositions may further comprise from about 15% to about 60% protein, from about 5% to about 40% fat, from about 5% to about 60% carbohydrate, and/or from about 0.5% to about 5% fiber.

In an embodiment, the chunks may be produced by emulsifying one or more of meat, dry proteinaceous materials, water and any additional ingredients. Optionally, the emulsion further comprises a flour such that the emulsion is a dough. Examples of suitable flours include wheat flour, amaranth flour, bean flour, white or brown rice flour, buckwheat flour, chestnut flour, chickpea flour, potato flour, corn flour, nut flour grated from oily nuts, pea flour, peanut flour, rye flour, tapioca flour, soy flour and the like. The chunks are not limited to a specific flour, and any flour known to the skilled artisan for making a dough may be used.

The emulsion may be formed using equipment commonly used in meat emulsification such as a mixer, a blender, a grinder, a silent cutter chopper, an emulsion mill, and the like. The other ingredients of the chunks may be added to the meat prior to and/or after emulsification of the meat. The emulsion may then be processed by a high-speed emulsion mill in a second emulsion step in which the emulsion is thermally gelled by rapid heating. The heated emulsion may then be cooled. For example, the heated emulsion may be discharged from the mill into a heat exchanger to lower the temperature of the emulsion and to solidify the emulsion into a striated meat-like structure.

The striated meat-like structure may be sliced into pieces to create the meat analog chunks. For example, a dicer, a rotary cut-off knife, a water jet knife, a knife grid or the like may cut the product into pieces of desired sizes. In an embodiment, portions of the striated meat-like structure may be processed differently to create pieces of different sizes.

In a preferred embodiment, the gravy is prepared separately from the chunks. For example, prior to mixing the gravy with the chunks, the gravy may be mixed by standard means well known in the art. In an embodiment, the gravy may be formed by adding the non-water components of the gravy to the water during continuous mixing, such as by a high-speed mixer, and the gravy may be formed at ambient temperatures. In another embodiment, the gravy may be formed by mixing the non-water components of the gravy in a portion of the water at ambient temperatures to form a slurry, heating the other portion of the water, and then adding the slurry to the heated water during continuous stirring, such as by an agitator.

In view of the preceding disclosures, in one aspect, is a method of making a wet pet food formulated for administration to a pet, the method comprising incorporating at least one palatant into the wet pet food in an amount effective to enhance palatability of the pet food and incorporating at least one combination of compounds as listed in Table 1 in a ratio as listed in Table 10.

In some embodiments, the method comprises producing the wet food as a chunks-in-gravy composition. The incorporating of the precursor or ingredient that provides the palatant or the palatant and at least one combination of compounds of Table 10 in ratios listed in Table 10 into the wet food may comprise at least one step selected from the group consisting of: (i) producing the gravy by a process comprising adding the precursor or ingredient or palatant and/or combination from Table 10 to one or more other ingredients of the gravy; (ii) producing the gravy by a process comprising adding a precursor, palatant, or ingredient and/or combination form Table 10 to one or more other ingredients of the gravy; and (iii) producing the chunks by a process comprising adding the precursor, palatant, ingredient, and/or the combination from Table 10 to one or more other ingredients of the chunks. In some embodiments, the method comprises producing the wet food as a loaf composition, preferably by incorporating both precursor, palatant, ingredient, and/or combination from Table 10 into the loaf composition. In a preferred embodiment, the palatant and the combination of compounds are formed during manufacturing from precursors or ingredients that contain the palatant.

In some embodiments, the method comprises the wet food is formulated for administration to a cat, preferably for complete nutrition of the cat, e.g., can be a complete and balanced pet food.

Another embodiment is a method of providing nutrition to a pet, the method comprising administering a wet food made by any method disclosed herein to the pet. The pet is preferably a cat. The pet may have or be at risk of renal failure, and the wet food may be free or substantially free of any of added phosphate or polyphosphate salts such as diphosphate salt, e.g., trisodium diphosphate.

### EXAMPLES

The following non-limiting examples further support the compositions and methods disclosed herein. “GiG” refers to chunks having the appearance of grilled meat and made by one or more of the methods disclosed in U.S. Pat. Nos. 10,993,445 and 10,470,470, incorporated herein by reference in their entireties, and includes the commercial product FANCY FEAST®. “CiG” refers to chunks of real meat without artificial additives (except vitamins and minerals). “Loaf” refers to a mousse product. “HsCC” refers to a terrine product.

### Example 1

Various commercial products were analyzed to determine volatile commands that positively affected or negatively affected palatability. Tables 1 and 2 show the concentrations in ppm (mg/1) as measured using an external calibration by GC/MS of the discovered volatile compounds from the various commercial CiG or GiG pet foods.

TABLE 1

| | | | Purina ® One ® | Royal | | FRISKIES ® |
|---|---|---|---|---|---|---|
| | | Fancy | Adult Mini | Canin ® | Gourmet ™ | pour chat adulte - |
| | Felix ® | Feast ® | Fillets in Gravy | Care- | Gold Fine | Sachets |
| | Sensations ® | Gourmet ™ | with Chicken | Digest | composition | fraîcheur en |
| | in Duck and | Grilled Tuna | and Green | Sensitive en | Canard et | sauce au |
| | Carrot sauce | Feast | Beans | sauce | dinde | saumon et thon |
| | (Poland) | (USA) | (Poland) | (France) | (France) | (France) |
| Compounds for | Gravy 1 | Gravy 2 | Gravy 3 | Gravy 4 | Gravy 5 | Gravy 6 |
| Palatability | | | | | | |
| increase | | | | | | |
| Dimethyl sulphide | 0.0581 | 0.7496 | 0.0558 | 0.0934 | 0.0904 | 0.1303 |
| Isoamyl alcohol | 0.1802 | 0.0899 | 0.0599 | 0.0135 | 0.1545 | 0.1635 |
| 2-methyloxolan-3-one | 0.0728 | 0.0793 | 0.0775 | 0.051 | 0.074 | 0.0661 |
| 2,5- | 0.4378 | 0.9513 | 0.5691 | 0.5457 | 0.5374 | 0.6772 |
| Dimethylpyrazine | | | | | | |
| 2-Ethyl-3,5- | 0.0034 | 0.0059 | 0.003 | 0.0004 | 0.0017 | 0.0017 |
| dimethylpyrazine | | | | | | |
| Furfural | 0.0279 | 0.0301 | 0.017 | 0.0172 | 0.0084 | 0.0085 |
| Furfuryl alcohol | 6.5101 | 9.3744 | 6.3552 | 1.8647 | 2.3286 | 1.1293 |
| Compounds for | Gravy 1 | Gravy 2 | Gravy 3 | Gravy 4 | Gravy 5 | Gravy 6 |
| Palatability | | | | | | |
| decrease | | | | | | |
| 2,4- | 0.0002 | 0.0005 | 0.0004 | 0.0007 | 0.0008 | 0.0008 |
| Dimethylfuran | | | | | | |
| 2-Heptanone | 0.7176 | 0.9715 | 1.206 | 0.7783 | 1.3892 | 0.8282 |
| 4-Methylthiazole | 0.0041 | 0.0114 | 0.0047 | 0.0124 | 0.0372 | 0.0195 |
| 2-Ethylpyrazine | 0.0134 | 0.044 | 0.0176 | 0.0276 | 0.0417 | 0.0356 |
| Dimethyl | 0.0441 | 0.0106 | 0.0244 | 0.0062 | 0.0272 | 0.2296 |
| trisulphide | | | | | | |
| Tetrahydrothiophen-3-one | 0.0115 | 0.0484 | 0.0231 | 0.0246 | 0.0995 | 0.0715 |
| 2- | 0.0661 | 0.2483 | 0.1129 | 0.1267 | 0.5395 | 0.4657 |
| Acetylthiophene | | | | | | |

TABLE 2

| | | | Gourmet ® Gold | | | |
|---|---|---|---|---|---|---|
| | Gourmet ™_{—} | | Les Mousselines | | | |
| | Les Terrines | | chicken | | | |
| | avec des | | (commercial | Sheba ® | GOURMET ® | |
| | Légumes - | | product with | Terrines | GOLD | GOURMET ® |
| | Canard, | Gourmet ™ | added tomato | Classiques | Les | GOLD Les |
| | carotte, | Souffé au | powder and | Coffret | Mousselines | Mousselines |
| | épinards | poulet | viscera) | Traiteur | Thon | Poulet |
| | (France) | (France) | (France) | (France) | (France) | (France) |
| Compounds for | Mousse 1 | Mousse 2 | Mousse 3 | Mousse 4 | Mousse 5 | Mousse 6 |
| Palatability | | | | | | |
| increase | | | | | | |
| Dimethyl sulphide | 0.4769 | 0.1177 | 2.2395 | 0.1526 | 0.2733 | 0.2332 |
| Isoamyl alcohol | 0.0847 | 0.0221 | 0.621 | 0.0417 | 0.3448 | 0.0398 |
| 2-methyloxolan-3-one | 0.1281 | 0.0552 | 0.5145 | 0.0643 | 0.1169 | 0.1982 |
| 2,5- | 0.0811 | 0.1807 | 1.5229 | 0.0893 | 0.1783 | 0.362 |
| Dimethylpyrazine | | | | | | |
| 2-Ethyl-3,5- | 0.0008 | 0.001 | 0.0044 | 0.0007 | 0.0008 | 0.0018 |
| dimethylpyrazine | | | | | | |
| Furfural | 0.0107 | 0.0492 | 0.0227 | 0.0051 | 0.0058 | 0.0128 |
| Furfuryl alcohol | 1.3895 | 28.3942 | 5.5202 | 0.931 | 1.3141 | 1.8671 |
| Compounds for | Mousse 1 | Mousse 2 | Mousse 3 | Mousse 4 | Mousse 5 | Mousse 6 |
| Palatability | | | | | | |
| decrease | | | | | | |
| 2,4- | 0.0002 | 0.0002 | 0.0014 | 0.0004 | 0.0006 | 0.0009 |
| Dimethylfuran | | | | | | |
| 2-Heptanone | 0.4404 | 0.3559 | 0.3136 | 0.4468 | 0.135 | 0.65 |
| 4-Methylthiazole | 0.0073 | 0.0036 | 0.053 | 0.017 | 0.0154 | 0.0144 |
| 2-Ethylpyrazine | 0.0217 | 0.0261 | 0.1031 | 0.0661 | 0.0277 | 0.0317 |
| Dimethyl | 0.012 | 0.023 | 0.0395 | 0.1139 | 0.1572 | 0.073 |
| trisulphide | | | | | | |
| Tetrahydrothiophen-3-one | 0.0545 | 0.0302 | 0.1268 | 0.0771 | 0.0775 | 0.1301 |
| 2- | 0.1727 | 0.1792 | 0.2958 | 0.4925 | 0.1498 | 0.1253 |
| Acetylthiophene | | | | | | |

Additionally, various ratios were calculated between each palatability-increasing volatile and each of the palatability-decreasing volatiles as shown in Tables 3-9.

TABLE 3

| Dimethyl sulphide Ratio to: | Gravy 1 | Gravy 2 | Gravy 3 | Gravy 4 | Gravy 5 | Gravy 6 |
|---|---|---|---|---|---|---|
| 2,4-Dimethylfuran | 290.50 | 1499.20 | 139.50 | 133.43 | 113.00 | 162.88 |
| 2-Heptanone | 0.08 | 0.77 | 0.05 | 0.12 | 0.07 | 0.16 |
| 4-Methylthiazole | 14.17 | 65.75 | 11.87 | 7.53 | 2.43 | 6.68 |
| 2-Ethylpyrazine | 4.34 | 17.04 | 3.17 | 3.38 | 2.17 | 3.66 |
| Dimethyl trisulphide | 18.80 | 70.72 | 2.29 | 15.06 | 3.32 | 0.57 |
| Tetrahydrothiophen-3-one | 5.05 | 15.49 | 2.42 | 3.80 | 0.91 | 1.82 |
| 2-Acetylthiophene | 0.88 | 3.02 | 0.49 | 0.74 | 0.17 | 0.28 |
| | Mousse | Mousse | Mousse | Mousse | Mousse | Mousse |
| Dimethyl sulphide Ratio to: | 1 | 2 | 3 | 4 | 5 | 6 |
| 2,4-Dimethylfuran | 2384.50 | 588.50 | 1599.64 | 381.50 | 455.50 | 259.11 |
| 2-Heptanone | 1.08 | 0.33 | 7.14 | 0.34 | 2.02 | 0.36 |
| 4-Methylthiazole | 65.33 | 32.69 | 42.25 | 8.98 | 17.75 | 16.19 |
| 2-Ethylpyrazine | 21.98 | 4.51 | 21.72 | 2.31 | 9.87 | 7.36 |
| Dimethyl trisulphide | 39.74 | 5.12 | 56.70 | 1.34 | 1.74 | 3.19 |
| Tetrahydrothiophen-3-one | 8.75 | 3.90 | 17.66 | 1.98 | 3.53 | 1.79 |
| 2-Acetylthiophene | 2.76 | 0.66 | 7.57 | 0.31 | 1.82 | 1.86 |

TABLE 4

| Isoamyl alcohol Ratio to: | Gravy 1 | Gravy 2 | Gravy 3 | Gravy 4 | Gravy 5 | Gravy 6 |
|---|---|---|---|---|---|---|
| 2,4-Dimethylfuran | 901.00 | 179.8 | 149.75 | 19.29 | 193.125 | 204.375 |
| 2-Heptanone | 0.25 | 0.093 | 0.050 | 0.017 | 0.111 | 0.197 |
| 4-Methylthiazole | 43.95 | 7.886 | 12.745 | 1.089 | 4.153 | 8.385 |
| 2-Ethylpyrazine | 13.45 | 2.043 | 3.403 | 0.489 | 3.705 | 4.593 |
| Dimethyl trisulphide | 4.09 | 8.481 | 2.455 | 2.177 | 5.680 | 0.712 |
| Tetrahydrothiophen-3-one | 15.67 | 1.857 | 2.593 | 0.549 | 1.553 | 2.287 |
| 2-Acetylthiophene | 2.73 | 0.362 | 0.531 | 0.107 | 0.286 | 0.351 |
| | Mousse | Mousse | Mousse | Mousse | Mousse | Mousse |
| Isoamyl alcohol Ratio to: | 1 | 2 | 3 | 4 | 5 | 6 |
| 2,4-Dimethylfuran | 423.5 | 110.5 | 443.57 | 104.25 | 574.67 | 44.22 |
| 2-Heptanone | 0.192 | 0.062 | 1.980 | 0.093 | 2.554 | 0.061 |
| 4-Methylthiazole | 11.603 | 6.139 | 11.717 | 2.453 | 22.390 | 2.764 |
| 2-Ethylpyrazine | 3.903 | 0.847 | 6.023 | 0.631 | 12.448 | 1.256 |
| Dimethyl trisulphide | 7.058 | 0.961 | 15.722 | 0.366 | 2.193 | 0.545 |
| Tetrahydrothiophen-3-one | 1.554 | 0.732 | 4.897 | 0.541 | 4.449 | 0.306 |
| 2-Acetylthiophene | 0.490 | 0.123 | 2.099 | 0.085 | 2.302 | 0.318 |

TABLE 5

| 2-methyloxolan-3-one Ratio to: | Gravy 1 | Gravy 2 | Gravy 3 | Gravy 4 | Gravy 5 | Gravy 6 |
|---|---|---|---|---|---|---|
| 2,4-Dimethylfuran | 364.00 | 158.60 | 193.75 | 72.86 | 92.50 | 82.63 |
| 2-Heptanone | 0.10 | 0.08 | 0.06 | 0.07 | 0.05 | 0.08 |
| 4-Methylthiazole | 17.76 | 6.96 | 16.49 | 4.11 | 1.99 | 3.39 |
| 2-Ethylpyrazine | 5.43 | 1.80 | 4.40 | 1.85 | 1.77 | 1.86 |
| Dimethyl trisulphide | 1.65 | 7.48 | 3.18 | 8.23 | 2.72 | 0.29 |
| Tetrahydrothiophen-3-one | 6.33 | 1.64 | 3.35 | 2.07 | 0.74 | 0.92 |
| 2-Acetylthiophene | 1.10 | 0.32 | 0.69 | 0.40 | 0.14 | 0.14 |
| | Mousse | Mousse | Mousse | Mousse | Mousse | Mousse |
| 2-methyloxolan-3-one Ratio to: | 1 | 2 | 3 | 4 | 5 | 6 |
| 2,4-Dimethylfuran | 640.50 | 276.00 | 367.50 | 160.75 | 194.83 | 220.22 |
| 2-Heptanone | 0.29 | 0.16 | 1.64 | 0.14 | 0.87 | 0.30 |
| 4-Methylthiazole | 17.55 | 15.33 | 9.71 | 3.78 | 7.59 | 13.76 |
| 2-Ethylpyrazine | 5.90 | 2.11 | 4.99 | 0.97 | 4.22 | 6.25 |
| Dimethyl trisulphide | 10.68 | 2.40 | 13.03 | 0.56 | 0.74 | 2.72 |
| Tetrahydrothiophen-3-one | 2.35 | 1.83 | 4.06 | 0.83 | 1.51 | 1.52 |
| 2-Acetylthiophene | 0.74 | 0.31 | 1.74 | 0.13 | 0.78 | 1.58 |

TABLE 6

| 2,5-Dimethylpyrazine Ratio to: | Gravy 1 | Gravy 2 | Gravy 3 | Gravy 4 | Gravy 5 | Gravy 6 |
|---|---|---|---|---|---|---|
| 2,4-Dimethylfuran | 2189 | 1902.6 | 1422.75 | 779.57 | 671.75 | 846.5 |
| 2-Heptanone | 0.61 | 0.98 | 0.47 | 0.70 | 0.39 | 0.82 |
| 4-Methylthiazole | 106.78 | 83.45 | 121.09 | 44.01 | 14.45 | 34.73 |
| 2-Ethylpyrazine | 32.67 | 21.62 | 32.34 | 19.77 | 12.89 | 19.02 |
| Dimethyl trisulphide | 9.93 | 89.75 | 23.32 | 88.02 | 19.76 | 2.95 |
| Tetrahydrothiophen-3-one | 38.07 | 19.65 | 24.64 | 22.18 | 5.40 | 9.47 |
| 2-Acetylthiophene | 6.62 | 3.83 | 5.04 | 4.31 | 1.00 | 1.45 |
| | Mousse | Mousse | Mousse | Mousse | Mousse | Mousse |
| 2,5-Dimethylpyrazine Ratio to: | 1 | 2 | 3 | 4 | 5 | 6 |
| 2,4-Dimethylfuran | 405.5 | 903.5 | 1087.79 | 223.25 | 297.17 | 402.22 |
| 2-Heptanone | 0.18 | 0.51 | 4.86 | 0.20 | 1.32 | 0.56 |
| 4-Methylthiazole | 11.11 | 50.19 | 28.73 | 5.25 | 11.58 | 25.14 |
| 2-Ethylpyrazine | 3.74 | 6.92 | 14.77 | 1.35 | 6.44 | 11.42 |
| Dimethyl trisulphide | 6.76 | 7.86 | 38.55 | 0.78 | 1.13 | 4.96 |
| Tetrahydrothiophen-3-one | 1.49 | 5.98 | 12.01 | 1.16 | 2.30 | 2.78 |
| 2-Acetylthiophene | 0.47 | 1.01 | 5.15 | 0.18 | 1.19 | 2.89 |

TABLE 7

| 2-Ethyl-3,5-dimethylpyrazine Ratio to: | Gravy 1 | Gravy 2 | Gravy 3 | Gravy 4 | Gravy 5 | Gravy 6 |
|---|---|---|---|---|---|---|
| 2,4-Dimethylfuran | 17 | 11.8 | 7.5 | 0.57 | 2.125 | 2.125 |
| 2-Heptanone | 0.00 | 0.01 | 0.0025 | 0.0005 | 0.0012 | 0.0021 |
| 4-Methylthiazole | 0.83 | 0.52 | 0.64 | 0.03 | 0.05 | 0.09 |
| 2-Ethylpyrazine | 0.25 | 0.13 | 0.17 | 0.01 | 0.04 | 0.05 |
| Dimethyl trisulphide | 0.08 | 0.56 | 0.12 | 0.06 | 0.06 | 0.01 |
| Tetrahydrothiophen-3-one | 0.30 | 0.12 | 0.13 | 0.02 | 0.02 | 0.02 |
| 2-Acetylthiophene | 0.05 | 0.02 | 0.03 | 0.00 | 0.00 | 0.00 |
| | Mousse | Mousse | Mousse | Mousse | Mousse | Mousse |
| 2-Ethyl-3,5-dimethylpyrazine Ratio to: | 1 | 2 | 3 | 4 | 5 | 6 |
| 2,4-Dimethylfuran | 4.00 | 5.00 | 3.14 | 1.75 | 1.33 | 2 |
| 2-Heptanone | 0.0018 | 0.0028 | 0.0140 | 0.0016 | 0.0059 | 0.0028 |
| 4-Methylthiazole | 0.11 | 0.28 | 0.08 | 0.04 | 0.05 | 0.13 |
| 2-Ethylpyrazine | 0.04 | 0.04 | 0.04 | 0.01 | 0.03 | 0.06 |
| Dimethyl trisulphide | 0.07 | 0.04 | 0.11 | 0.01 | 0.01 | 0.02 |
| Tetrahydrothiophen-3-one | 0.01 | 0.03 | 0.03 | 0.01 | 0.01 | 0.01 |
| 2-Acetylthiophene | 0.00 | 0.01 | 0.01 | 0.00 | 0.01 | 0.01 |

TABLE 8

| Furfural Ratio to: | Gravy 1 | Gravy 2 | Gravy 3 | Gravy 4 | Gravy 5 | Gravy 6 |
|---|---|---|---|---|---|---|
| 2,4-Dimethylfuran | 139.5 | 60.2 | 42.5 | 24.57 | 10.5 | 10.63 |
| 2-Heptanone | 0.04 | 0.03 | 0.014 | 0.022 | 0.006 | 0.010 |
| 4-Methylthiazole | 6.80 | 2.64 | 3.62 | 1.39 | 0.23 | 0.44 |
| 2-Ethylpyrazine | 2.08 | 0.68 | 0.97 | 0.62 | 0.20 | 0.24 |
| Dimethyl trisulphide | 0.63 | 2.84 | 0.70 | 2.77 | 0.31 | 0.04 |
| Tetrahydrothiophen-3-one | 2.43 | 0.62 | 0.74 | 0.70 | 0.08 | 0.12 |
| 2-Acetylthiophene | 0.42 | 0.12 | 0.15 | 0.14 | 0.02 | 0.02 |
| | Mousse | Mousse | Mousse | Mousse | Mousse | Mousse |
| Furfural Ratio to: | 1 | 2 | 3 | 4 | 5 | 6 |
| 2,4-Dimethylfuran | 53.5 | 246 | 16.21 | 12.75 | 9.67 | 14.22 |
| 2-Heptanone | 0.024 | 0.138 | 0.072 | 0.011 | 0.043 | 0.020 |
| 4-Methylthiazole | 1.47 | 13.67 | 0.43 | 0.30 | 0.38 | 0.89 |
| 2-Ethylpyrazine | 0.49 | 1.89 | 0.22 | 0.08 | 0.21 | 0.40 |
| Dimethyl trisulphide | 0.89 | 2.14 | 0.57 | 0.04 | 0.04 | 0.18 |
| Tetrahydrothiophen-3-one | 0.20 | 1.63 | 0.18 | 0.07 | 0.07 | 0.10 |
| 2-Acetylthiophene | 0.06 | 0.27 | 0.08 | 0.01 | 0.04 | 0.10 |

TABLE 9

| Furfuryl alcohol Ratio to: | Gravy 1 | Gravy 2 | Gravy 3 | Gravy 4 | Gravy 5 | Gravy 6 |
|---|---|---|---|---|---|---|
| 2,4-Dimethylfuran | 32550.5 | 18748.8 | 15888.0 | 2663.9 | 2910.8 | 1411.6 |
| 2-Heptanone | 9.07 | 9.65 | 5.27 | 2.40 | 1.68 | 1.36 |
| 4-Methylthiazole | 1587.83 | 822.32 | 1352.17 | 150.38 | 62.60 | 57.91 |
| 2-Ethylpyrazine | 485.83 | 213.05 | 361.09 | 67.56 | 55.84 | 31.72 |
| Dimethyl trisulphide | 147.62 | 884.38 | 260.46 | 300.76 | 85.61 | 4.92 |
| Tetrahydrothiophen-3-one | 566.10 | 193.69 | 275.12 | 75.80 | 23.40 | 15.79 |
| 2-Acetylthiophene | 98.49 | 37.75 | 56.29 | 14.72 | 4.32 | 2.42 |

| | Mousse | Mousse | Mousse | Mousse | Mousse | Mousse |
|---|---|---|---|---|---|---|
| Furfuryl alcohol Ratio to: | 1 | 2 | 3 | 4 | 5 | 6 |
| 2,4-Dimethylfuran | 6947.5 | 141971.0 | 3943.0 | 2327.5 | 2190.2 | 2074.6 |
| 2-Heptanone | 3.16 | 79.78 | 17.60 | 2.08 | 9.73 | 2.87 |
| 4-Methylthiazole | 190.34 | 7887.28 | 104.15 | 54.76 | 85.33 | 129.66 |
| 2-Ethylpyrazine | 64.03 | 1087.90 | 53.54 | 14.08 | 47.44 | 58.90 |
| Dimethyl trisulphide | 115.79 | 1234.53 | 139.75 | 8.17 | 8.36 | 25.58 |
| Tetrahydrothiophen-3-one | 25.50 | 940.21 | 43.53 | 12.08 | 16.96 | 14.35 |
| 2-Acetylthiophene | 8.05 | 158.45 | 18.66 | 1.89 | 8.77 | 14.90 |

From the compounds, various combinations of ratios were found to provide enhanced palatable pet foods previous unknown as shown in Table 10.

TABLE 10

| Combination | Compounds | Ratio |
|---|---|---|
| 1 | Dimethyl sulphide to 2-Acetylthiophene | >3.5 |
| | Isoamyl alcohol to Tetrahydrothiophen-3-one | >5 |
| 2 | Dimethyl sulphide to 2-Acetylthiophene | >3.5 |
| | 2-methyloxolan-3-one to Tetrahydrothiophen-3-one | >5 |
| 3 | Isoamyl alcohol to Tetrahydrothiophen-3-one | >5 |
| | 2,5-Dimethylpyrazine to 2-Heptanone | >1.5 |
| 4 | 2-methyloxolan-3-one to Tetrahydrothiophen-3-one | >5 |
| | 2,5-Dimethylpyrazine to 2-Heptanone | >1.5 |
| 5 | Isoamyl alcohol to Tetrahydrothiophen-3-one | >5 |
| | 2,5-Dimethylpyrazine to 2-Heptanone | >1.5 |
| 6 | 2,5-Dimethylpyrazine to 2-Heptanone | >1.5 |
| | 2,5-Dimethylpyrazine to Tetrahydrothiophen-3-one | >25 |
| 7 | Dimethyl sulphide to 2-Acetylthiophene | >3.5 |
| | 2,5-Dimethylpyrazine to Tetrahydrothiophen-3-one | >25 |
| 8 | 2,5-Dimethylpyrazine to 2-Heptanone | >1.5 |
| | 2,5-Dimethylpyrazine to 2-Acetylthiophene | >6 |
| 9 | Dimethyl sulphide to 2-Acetylthiophene | >3.5 |
| | 2,5-Dimethylpyrazine to 2-Acetylthiophene | >6 |
| 10 | 2,5-Dimethylpyrazine to 2-Acetylthiophene | >6 |
| | 2-Ethyl-3,5-dimethylpyrazine to Dimethyl trisulphide | >0.15 |
| 11 | 2,5-Dimethylpyrazine to Tetrahydrothiophen-3-one | >25 |
| | 2-Ethyl-3,5-dimethylpyrazine to Dimethyl trisulphide | >0.15 |
| 12 | 2,5-Dimethylpyrazine to 2-Heptanone | >1.5 |
| | 2-Ethyl-3,5-dimethylpyrazine to Dimethyl trisulphide | >0.15 |
| 13 | 2-methyloxolan-3-one to Tetrahydrothiophen-3-one | >5 |
| | 2-Ethyl-3,5-dimethylpyrazine to Dimethyl trisulphide | >0.15 |
| 14 | Isoamyl alcohol to Tetrahydrothiophen-3-one | >5 |
| | 2-Ethyl-3,5-dimethylpyrazine to Dimethyl trisulphide | >0.15 |
| 15 | Dimethyl sulphide to 2-Acetylthiophene | >3.5 |
| | 2-Ethyl-3,5-dimethylpyrazine to Dimethyl trisulphide | >0.15 |
| 16 | 2-Ethyl-3,5-dimethylpyrazine to Dimethyl trisulphide | >0.15 |
| | 2-Ethyl-3,5-dimethylpyrazine to Tetrahydrothiophen-3-one | >0.15 |
| 17 | 2,5-Dimethylpyrazine to 2-Heptanone | >1.5 |
| | 2-Ethyl-3,5-dimethylpyrazine to Tetrahydrothiophen-3-one | >0.15 |
| 18 | Dimethyl sulphide to 2-Acetylthiophene | >3.5 |
| | 2-Ethyl-3,5-dimethylpyrazine to Tetrahydrothiophen-3-one | >0.15 |
| 19 | 2-Ethyl-3,5-dimethylpyrazine to Tetrahydrothiophen-3-one | >0.15 |
| | Furfural to 2-Heptanone | >0.10 |
| 20 | 2-Ethyl-3,5-dimethylpyrazine to Dimethyl trisulphide | >0.15 |
| | Furfural to 2-Heptanone | >0.10 |
| 21 | 2,5-Dimethylpyrazine to 2-Acetylthiophene | >6 |
| | Furfural to 2-Heptanone | >0.10 |
| 22 | 2,5-Dimethylpyrazine to Tetrahydrothiophen-3-one | >25 |
| | Furfural to 2-Heptanone | >0.10 |
| 23 | 2,5-Dimethylpyrazine to 2-Heptanone | >1.5 |
| | Furfural to 2-Heptanone | >0.10 |
| 24 | 2-methyloxolan-3-one to Tetrahydrothiophen-3-one | >5 |
| | Furfural to 2-Heptanone | >0.10 |
| 25 | Isoamyl alcohol to Tetrahydrothiophen-3-one | >5 |
| | Furfural to 2-Heptanone | >0.10 |
| 26 | Dimethyl sulphide to 2-Acetylthiophene | >3.5 |
| | Furfural to 2-Heptanone | >0.10 |
| 27 | Furfural to 2-Heptanone | >0.10 |
| | Furfural to 2-Acetylthiophene | >0.30 |
| 28 | Furfural to 2-Acetylthiophene | >0.30 |
| | 2-Ethyl-3,5-dimethylpyrazine to Dimethyl trisulphide | >0.15 |
| 29 | Furfural to 2-Acetylthiophene | >0.30 |
| | 2,5-Dimethylpyrazine to 2-Heptanone | >1.5 |
| 30 | Furfural to 2-Acetylthiophene | >0.30 |
| | Dimethyl sulphide to 2-Acetylthiophene | >3.5 |

It should be understood that various changes and modifications to the presently preferred embodiments described herein will be apparent to those skilled in the art. Such changes and modifications may be made without departing from the spirit and scope of the present subject matter and without diminishing its intended advantages. It is therefore intended that such changes and modifications be covered by the appended claims.

1. A pet food composition comprising a palatant selected from the group consisting of dimethyl sulphide, isoamyl alcohol, 2-methyloxolan-3-one, 2,5-dimethylpyrazine, 2-ethyl-3,5-dimethylpyrazine, furfural, furfuryl alcohol, and combinations thereof, wherein the composition has at least one combination of compounds as provided in Table 10 in ratios as provided in Table 10:
TABLE 10

| Combination | Compounds | Ratio |
|---|---|---|
| 1 | Dimethyl sulphide to 2-Acetylthiophene | >3.5 |
| | Isoamyl alcohol to Tetrahydrothiophen-3-one | >5 |
| 2 | Dimethyl sulphide to 2-Acetylthiophene | >3.5 |
| | 2-methyloxolan-3-one to Tetrahydrothiophen-3-one | >5 |
| 3 | Isoamyl alcohol to Tetrahydrothiophen-3-one | >5 |
| | 2,5-Dimethylpyrazine to 2-Heptanone | >1.5 |
| 4 | 2-methyloxolan-3-one to Tetrahydrothiophen-3-one | >5 |
| | 2,5-Dimethylpyrazine to 2-Heptanone | >1.5 |
| 5 | Isoamyl alcohol to Tetrahydrothiophen-3-one | >5 |
| | 2,5-Dimethylpyrazine to 2-Heptanone | >1.5 |
| 6 | 2,5-Dimethylpyrazine to 2-Heptanone | >1.5 |
| | 2,5-Dimethylpyrazine to Tetrahydrothiophen-3-one | >25 |
| 7 | Dimethyl sulphide to 2-Acetylthiophene | >3.5 |
| | 2,5-Dimethylpyrazine to Tetrahydrothiophen-3-one | >25 |
| 8 | 2,5-Dimethylpyrazine to 2-Heptanone | >1.5 |
| | 2,5-Dimethylpyrazine to 2-Acetylthiophene | >6 |
| 9 | Dimethyl sulphide to 2-Acetylthiophene | >3.5 |
| | 2,5-Dimethylpyrazine to 2-Acetylthiophene | >6 |
| 10 | 2,5-Dimethylpyrazine to 2-Acetylthiophene | >6 |
| | 2-Ethyl-3,5-dimethylpyrazine to Dimethyl trisulphide | >0.15 |
| 11 | 2,5-Dimethylpyrazine to Tetrahydrothiophen-3-one | >25 |
| | 2-Ethyl-3,5-dimethylpyrazine to Dimethyl trisulphide | >0.15 |
| 12 | 2,5-Dimethylpyrazine to 2-Heptanone | >1.5 |
| | 2-Ethyl-3,5-dimethylpyrazine to Dimethyl trisulphide | >0.15 |
| 13 | 2-methyloxolan-3-one to Tetrahydrothiophen-3-one | >5 |
| | 2-Ethyl-3,5-dimethylpyrazine to Dimethyl trisulphide | >0.15 |
| 14 | Isoamyl alcohol to Tetrahydrothiophen-3-one | >5 |
| | 2-Ethyl-3,5-dimethylpyrazine to Dimethyl trisulphide | >0.15 |
| 15 | Dimethyl sulphide to 2-Acetylthiophene | >3.5 |
| | 2-Ethyl-3,5-dimethylpyrazine to Dimethyl trisulphide | >0.15 |
| 16 | 2-Ethyl-3,5-dimethylpyrazine to Dimethyl trisulphide | >0.15 |
| | 2-Ethyl-3,5-dimethylpyrazine to Tetrahydrothiophen-3-one | >0.15 |
| 17 | 2,5-Dimethylpyrazine to 2-Heptanone | >1.5 |
| | 2-Ethyl-3,5-dimethylpyrazine to Tetrahydrothiophen-3-one | >0.15 |
| 18 | Dimethyl sulphide to 2-Acetylthiophene | >3.5 |
| | 2-Ethyl-3,5-dimethylpyrazine to Tetrahydrothiophen-3-one | >0.15 |
| 19 | 2-Ethyl-3,5-dimethylpyrazine to Tetrahydrothiophen-3-one | >0.15 |
| | Furfural to 2-Heptanone | >0.10 |
| 20 | 2-Ethyl-3,5-dimethylpyrazine to Dimethyl trisulphide | >0.15 |
| | Furfural to 2-Heptanone | >0.10 |
| 21 | 2,5-Dimethylpyrazine to 2-Acetylthiophene | >6 |
| | Furfural to 2-Heptanone | >0.10 |
| 22 | 2,5-Dimethylpyrazine to Tetrahydrothiophen-3-one | >25 |
| | Furfural to 2-Heptanone | >0.10 |
| 23 | 2,5-Dimethylpyrazine to 2-Heptanone | >1.5 |
| | Furfural to 2-Heptanone | >0.10 |
| 24 | 2-methyloxolan-3-one to Tetrahydrothiophen-3-one | >5 |
| | Furfural to 2-Heptanone | >0.10 |
| 25 | Isoamyl alcohol to Tetrahydrothiophen-3-one | >5 |
| | Furfural to 2-Heptanone | >0.10 |
| 26 | Dimethyl sulphide to 2-Acetylthiophene | >3.5 |
| | Furfural to 2-Heptanone | >0.10 |
| 27 | Furfural to 2-Heptanone | >0.10 |
| | Furfural to 2-Acetylthiophene | >0.30 |
| 28 | Furfural to 2-Acetylthiophene | >0.30 |
| | 2-Ethyl-3,5-dimethylpyrazine to Dimethyl trisulphide | >0.15 |
| 29 | Furfural to 2-Acetylthiophene | >0.30 |
| | 2,5-Dimethylpyrazine to 2-Heptanone | >1.5 |
| 30 | Furfural to 2-Acetylthiophene | >0.30 |
| | Dimethyl sulphide to 2-Acetylthiophene | >3.5 |

2. The pet food of claim 1, wherein the pet food composition further comprises protein, carbohydrates, fat, and fiber.

3. The pet food composition of claim 1, wherein the pet food composition is formulated for a cat.

4. The pet food composition of claim 1, wherein the pet food composition is a wet cat food.

5. The pet food composition of claim 4, wherein the wet cat food is a mousse or loaf composition.

6. The pet food composition of claim 4, wherein the wet cat food includes a gravy.

7. The pet food composition of claim 4, wherein the wet cat food is a chunks-in-gravy composition.

8. The pet food composition of claim 1, wherein the pet food has at least two combinations of ratios as provided in Table 10.

9. A method of making a pet food composition, method comprising:
incorporating a precursor of a palatant, an ingredient containing the palatant, or the palatant, wherein the palatant is selected from the group consisting of dimethyl sulphide, isoamyl alcohol, 2-methyloxolan-3-one, 2,5-dimethylpyrazine, 2-ethyl-3,5-dimethylpyrazine, furfural, furfuryl alcohol, and combinations thereof, into the pet food; and
incorporating a combination of compounds in table 10 in ratios as provided in Table 10 into the pet food, wherein the compounds are formed from precursors that are added to the pet food, are added as ingredients that contain the compounds, or are added directly to the pet food;
wherein the palatant and the combination of compounds are present in an amount effective to enhance palatability of the pet food composition.

10. The method of claim 9, wherein the pet food composition further comprises protein, carbohydrates, fat, and fiber.

11. The method of claim 9, wherein palatant and the combination of compounds are formed during manufacturing.

12. The method of claim 9, wherein the pet food composition is a wet cat food.

13. The method of claim 13, wherein the wet cat food is a mousse or loaf composition.

14. The method of claim 13, wherein the wet cat food includes a gravy.

15. The method of claim 13, wherein the wet cat food is a chunks-in-gravy composition.
